(19) United States
(12) Patent Application Publication
(10) Pub. No.: US 2021/0078157 A1
(43) Pub. Date: Mar. 18, 2021

(54) Carrying Case

(71) Applicant: Custom-Pak, Inc., Clinton, IA (US)

(72) Inventors: Andrew James McDonnough, Camanche, IA (US); Pamela Jo Naeve, Clinton, IA (US); Mariana Rojas, Mexicali B.C. (MX); Ruben Franco, Mexicali (MX)

(21) Appl. No.: 16/574,964

(22) Filed: Sep. 18, 2019

(51) Int. Cl. B25H 3/00; B29C 49/48; B29C 49/50

(52) U.S. Cl. CPC B25H 3/006; B29L 2031/712; B29C 49/50; B29C 49/4802

(57) ABSTRACT

A tool case with single and double wall sections, the double wall sections extend from one edge or from a corner of part of the case and are defined by a cut line, the cut line changes in height as the double wall sections have contours to conform to the tool to be held. The double wall sections may include supporting portions which are sections where the inner surfaces of the two walls are fused or welded together to create a support which transfers load from the tool between the two walls of the double wall section. In certain aspects, the cut line defines a large internal area of single wall as compared to the overall perimeter of the case or case half.

### FIELD OF THE INVENTION

The following relates to carrying cases, particularly blow molded carrying cases.

### BACKGROUND OF THE INVENTION

Blow molded tool cases are generally known in the art and blow molding is particularly useful for producing repeatable lightweight and strong carrying cases which are relatively inexpensive to produce. Despite the foregoing, a major expense in blow molding involves the plastic materials used. Thus, minimized costs might result in the design of a single wall blow molded case. However, this may result in a case that is not sufficiently durable or strong to withstand day to day usage, especially in environments where power tools and hand tools are regularly used and/or transported. Thus, double wall blow molded cases offer a particular strength and durability advantage as well as offering the ability to design the contours of the interior surface.

However, double wall cases can come at the disadvantage of using extra plastic material which increases costs.

Some cases have been designed such as the hybrid double and single wall case for a chain saw as disclosed and described in U.S. 2015-0083620.

However, it remains desirable to further reduce material usage where possible while providing sufficient durability and strength and to also provide for improved support for the tool in the case.

### SUMMARY OF THE INVENTION

Thus, it is an object of the invention to reduce the total area of double wall sections of a case while providing sufficient strength and durability.

It is further desirable to provide case with contoured double wall supports for the tool to keep it secure in the case while removing a large portion or as much of the rest of the double wall material as possible for recycling/re-use.

It is still a further object of the invention to provide adequate support of double wall sections to enable those sections to securely hold a tool when the case is closed.

As used herein “planform area” refers to a projection area within or between particular perimeter(s) or line(s) (which may exist in three dimensions) of one part on a plane such that the planform area is measured in two dimensions. For example, FIG. 1 shows one section of the tool case that has a separately attached part making up the handle. The outer perimeter of the case as seen from the plane would define the planform area. The inner cut 20 (see FIG. 2) that separates the double and single wall portions changes in height in and out of the page as seen from FIG. 1 such that the cut 20 is in three dimensions, thus its planform area in two dimensions between the outer perimeter and the cut 20 is measured as the projection on a plane rather than the surface area of the double wall.

The terms “first” and “second” are used to distinguish one element, set, data, object or thing from another, and are not used to designate relative position or arrangement in time.

These and other objects are achieved by providing a tool case with single and double wall sections, the double wall sections extend from one edge or from a corner of part of the case and are defined by a cut line, the cut line changes in height as the double wall sections have contours to conform to the tool to be held. The double wall sections may include supporting portions which are sections where the inner surfaces of the two walls are fused or welded together to create a support which transfers load from the tool between the two walls of the double wall section.

In one aspect the blow molded tool case includes a first section and a second section, the first and second sections are configured to pivot relative to each other and are blow molded. The first and second sections each have a length, height and thickness, the length measured along the pivot between the first and second sections, the thickness being less than the height, the thickness being measured in a first direction. A double wall section and a single wall section are separated by a cut line. The cut line defines a first edge and a second edge opposite the first edge and further defines a third edge and a fourth edge opposite the third edge. A portion of the double wall section extends inwards from the first edge such that a part of the cut line defining the portion of the double wall section has different heights relative to the first edge measured in the first direction.

In certain aspects the double wall section and the single wall section are on the first section. In other aspects the double wall section has at least a first and a second double wall section and the single wall section has at least a first and a second single wall section. The first double wall section and the first single wall section are located on the first section. The second double wall section and the second single wall section are located on the second section. In other aspects the portion of the double wall section extends inwards from two locations on the first edge towards a middle of the first section without extending all the way across the first section. In other aspects, the portion of the double wall section extends inwards from the third edge such that the part of the cut line extends inwards from the first edge and then outwards towards the third edge. In other aspects the first, second, third and fourth edges are at an equal height. In still other aspects the first and second edges are parallel and the third and fourth edges are parallel. In still other aspects the double wall section includes one or more supporting portions where outer and inner walls of the first section are fused together. In still other aspects a tool has a first contoured surface and the double wall section has a second contoured surface such that the first contoured surface inter-fits the second contoured surface. An edge of the second contoured surface is defined by the part of the cut line which has different heights relative to the first edge. A contoured surface on the double wall section has an edge defined by the part of the cut line which has different heights relative to the first edge. In still other aspects a parting line is defined where the first and second portions meet when the tool case is in a closed position. A first perimeter of the first portion defined at the case parting line. A second perimeter of the second portion defined at the case parting line. The cut line is a first cut line which has a first length which is the longest cut line of the first blow molded portion. The second blow molded portion has a second cut line which separates a double wall and a single wall portion of the second blow molded portion. The second cut line has a second length which is the longest cut line of the second blow molded portion. A sum of the first and second lengths is 75% or more than a sum of lengths of the first and second perimeters.

In other aspects a blow molded case includes a first blow molded portion and a second blow molded portion configured to pivot relative to the first blow molded portion and meet at a case parting line when the case is in a closed position. A first outer perimeter of the first blow molded portion is defined at the case parting line. A second outer perimeter of the second blow molded portion defined at the case parting line. The first blow molded portion has a first cut line which separates a double wall and a single wall portion of the first blow molded portion, the first cut line having a first length which is a longest cut line of the first blow molded portion. The second blow molded portion has a second cut line which separates a double wall and a single wall portion of the second blow molded portion. The second cut line has a second length which is a longest cut line of the second blow molded portion. A sum of the first and second lengths is 75% or more than a sum of lengths of the first outer perimeter and the second outer perimeter.

In particular aspects one or more depressions are located in at least one of the double wall portions, the one or more depressions being defined by first and second walls of the double wall portion being in contact. In certain aspects the contact between the first and second walls fuses the first and second walls together in a plastic weld. In other aspects the sum of the first and second lengths is greater than the sum of lengths of the first and second perimeters. In other aspects the first outer perimeter defines a first planform area on a plane and the second outer perimeter defines a second planform area on the plane. The first cut line defines a third planform area on the plane and the second cut line defining a fourth planform area on the plane and a sum of the third and fourth planform areas is at least 50% of a sum of the first and second planform areas. In still other aspects the sum of the third and fourth planform areas is at least 75% of the sum of the first and second planform areas.

In other aspects a blow molded case includes a first blow molded portion and a second blow molded portion configured to pivot relative to said first blow molded portion about an axis and meet at a case parting line when the case is in a closed position. The first blow molded portion has at least one first double wall portion and at least one first single wall portion separated by a cut line, the at least one first double wall portion extends inward in an inward direction transverse to the axis to define a first support and the cut line around the first support has different heights measured in a thickness direction perpendicular to the inward direction and the axis.

In other aspects the second blow molded portion has at least one second double wall portion and at least one second single wall portion separated by a cut line, the at least one second double wall portion defines a second support and extends inward in the inward direction. The cut line around the second support has different heights measured in the thickness direction. In other aspects a second at least one first double wall portion defines a second support and located in a corner of the first blow molded portion and the cut line around the second at least one first double wall portion has different heights measured in the thickness direction. In other aspects the first and second supports respectively are configured to support a handle end and a tool end of a tool. In other aspects one or more depressions are located in the first support, the one or more depressions being are defined by first and second walls of the corresponding double wall portion being in contact. In other aspects the one or more depressions make up a first area where the first and second walls are in contact which is less than 5% of an area defined by a perimeter of the first blow molded portion. In other aspects a first planform area between the cut line and a perimeter of the first blow molded portion is less than 20% of a second planform area defined by a perimeter of the first blow molded portion.

In still other aspects a blow molded case includes a first blow molded portion and a second blow molded portion configured to pivot relative to said first blow molded portion and meet at a case parting line when the case is in a closed position. A first outer perimeter of the first blow molded portion defined at the case parting line. The first blow molded portion has a first cut line within the first outer perimeter which separates a double wall and a single wall portion of the first blow molded portion. The first outer perimeter defines a first planform area on a plane and the first cut line defines a first cutline planform area on the plane. The first cutline planform area is at least 50% of the first planform area.

In particular aspects a second outer perimeter of the second blow molded portion is defined at the case parting line. The second blow molded portion has a second cut line which separates a double wall and a single wall portion of the second blow molded portion. The second outer perimeter defines a second planform area on the plane. The second cut line defines a second cutline planform area on the plane and the second cutline planform area is at least 60% of the second planform area.

In particular aspects the second cutline planform area is at least 75% of the second planform area. In still other aspects the first cutline planform area is at least 75% of the first planform area.

Other objects of the invention and its particular features and advantages will become more apparent from consideration of the following drawings and accompanying detailed description.

### BRIEF DESCRIPTION OF THE DRAWINGS

FIG. 1 is a perspective view of part of a tool case according to the present invention part way through manufacturing.

FIG. 2 is a perspective view of the case of FIG. 1 but showing a cut line.

FIG. 3 is a perspective view of FIGS. 1 and 2 after removal of the excess material inside the cut line.

FIG. 4 is a top view of FIG. 3.

FIG. 5 is a section view of FIG. 4 along line 5-5.

FIG. 6 is a section view of FIG. 4 alone line 6-6.

FIG. 7 shows a perspective view of the top half of the case of FIG. 3.

FIG. 8 is a rear perspective view of a tool case according to the present invention.

FIG. 9 shows a perspective view of the tool case of FIG. 8 in an open configuration.

FIG. 10 shows a perspective view of the bottom half of the tool case of FIG. 8.

FIG. 11 shows a perspective view of the top half of the tool case of FIG. 8.

### DETAILED DESCRIPTION OF THE INVENTION

Referring now to the drawings, wherein like reference numerals designate corresponding structure throughout the views. The following examples are presented to further illustrate and explain the present invention and should not be taken as limiting in any regard.

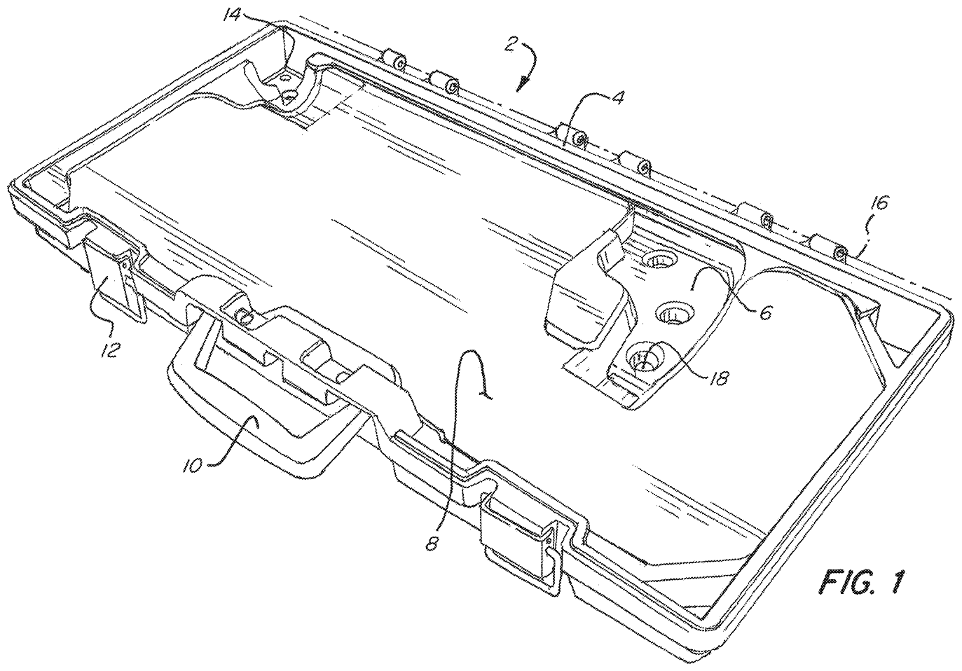

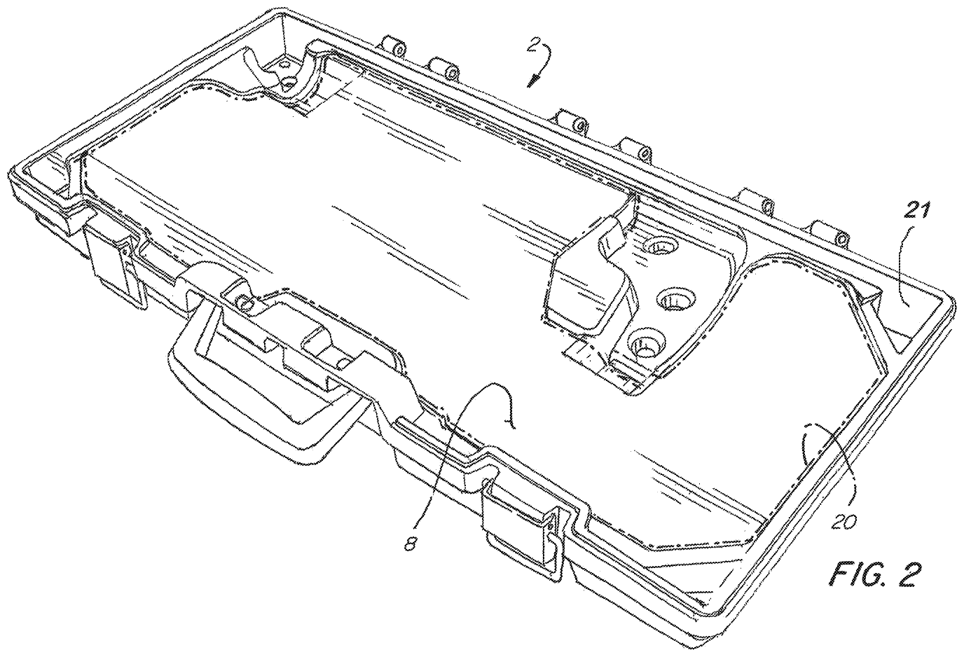

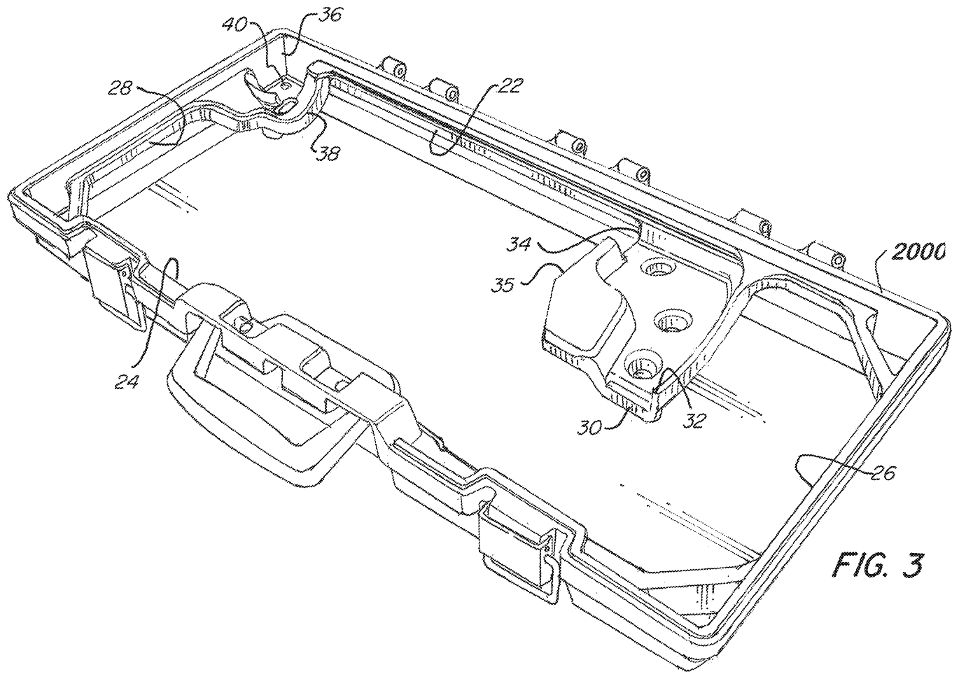

Referring to FIG. 1 one half 2 of the case is shown. The second half attaches through the hinges 4 to allow for rotation about axis 16. Support portion 6 is one portion of the double wall and as shown, the entire case is double wall prior to cutting. This is typically how the case would look after the molten parison is expanded against the mold but prior to cutting. The cutting can be done through an in-mold punch or with post molding cutting operations. In preferred embodiments, an in-mold punch is used. As shown in e.g. FIGS. 2-3, double wall portion 8 is eventually removed and can be recycled for later use, thus decreasing the amount of plastic used to manufacture each case. As can be seen, support 6 extends from one edge between the corners of the case. It is understood that support 6 can be considered to extend from one edge even if the actual cut line to either side thereof are offset but parallel or otherwise aligned with respect to each other. The particular example shown has the support 6 closer to one corner than the other as this particular case may be best suited for a reciprocating saw. However, it is understood that the specific positioning of the supports can vary based on the particular tool to be carried. Support 14 is also at a double wall section and in contrast to support 6 extends from two separate edges which are transverse and not parallel.

Depressions 18 in the support 6 provide increased rigidity of the support 6. Particularly, the depressions 18 are portions where the inner surfaces of the two walls which face each other are in contact or more particularly, fused together in a plastic weld. This results in loads placed on the support 6 being transferred to the opposite wall (which makes up the outer wall of the case). Thus, the depressions 18 configure the support 6 such that it is not cantilevered from the edge from which it extends. In certain embodiments, support 14 may be made without depressions 18 which cause contact (or fusing) between the two walls. Particularly, as support 14 extends from transverse edges, support 14 is less apt to bend compared to a cantilevered support. Furthermore, support 14 may not bear as much weight from the tool for which the embodiment shown is designed for typically has a heavier side where the motor is rather than where the blade is. For example, the reciprocating saw the depicted case is designed for is heavier near the handle which is supported by support 6. Support 14 takes less of the weight as it is at the blade end. In this example, the blade would be removed to allow for storage in the tool case.

As shown in FIG. 2, cut 20 is where section 8 is separated from the case during processing, preferably by an in mold punch. Thus, the interior of the perimeter defined by cut 20 is recycled and can be used in manufacturing subsequent cases. The corners without tool supports include indents 21 which provide for added rigidity and structure to inhibit warping and bending when the case is carried. In certain instances, the indents can include depressions 180 therein which are similar in structure to the depressions 18 as described herein. In particular aspects, the length of outline 20 (measured as a perimeter) is 70% or more, or particularly 70-130% or more particularly 85-115% relative to the outer perimeter 2000 length. The same ranges may hold true for the other case halves.

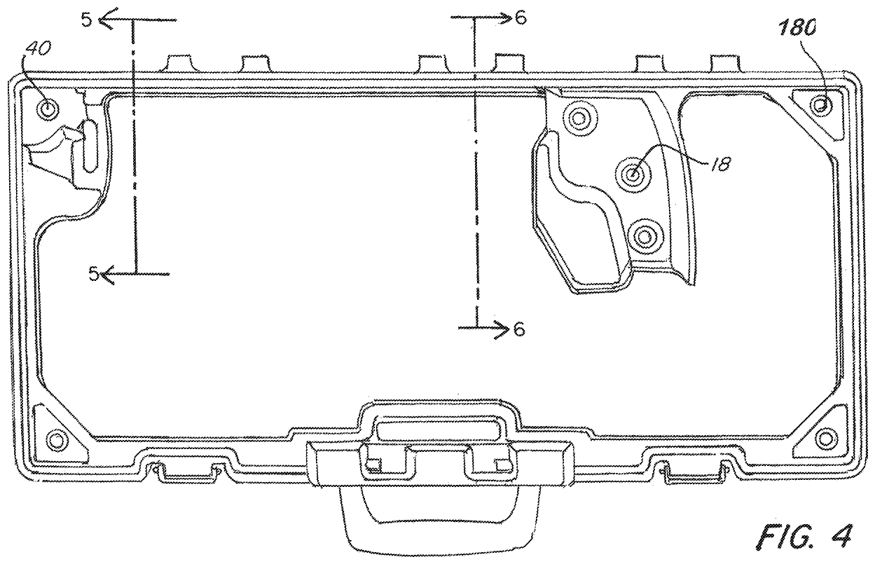

As shown in FIG. 3, the section 8 has been removed revealing the cut line which defines the separation between single and double wall portions of the case. Opposed pairs of edges 22/24 and 26/28 generally are straight and perpendicular to the other opposed pairs. As the supports are designed with contours to accept portions of the tool, the cut line at these supports varies in height relative to the Z axis (out of the page in FIG. 4) with the X axis being aligned with the axis 16.

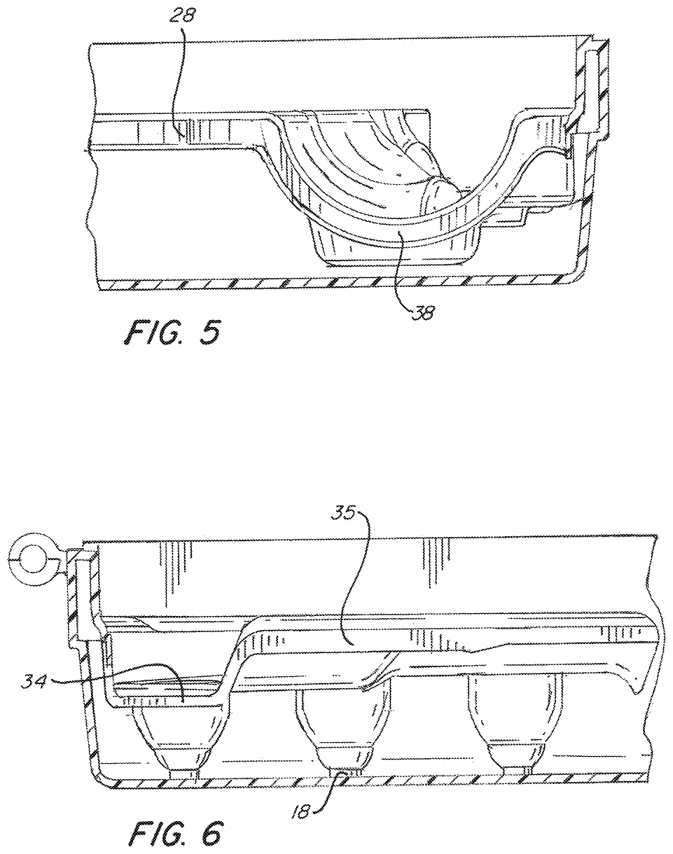

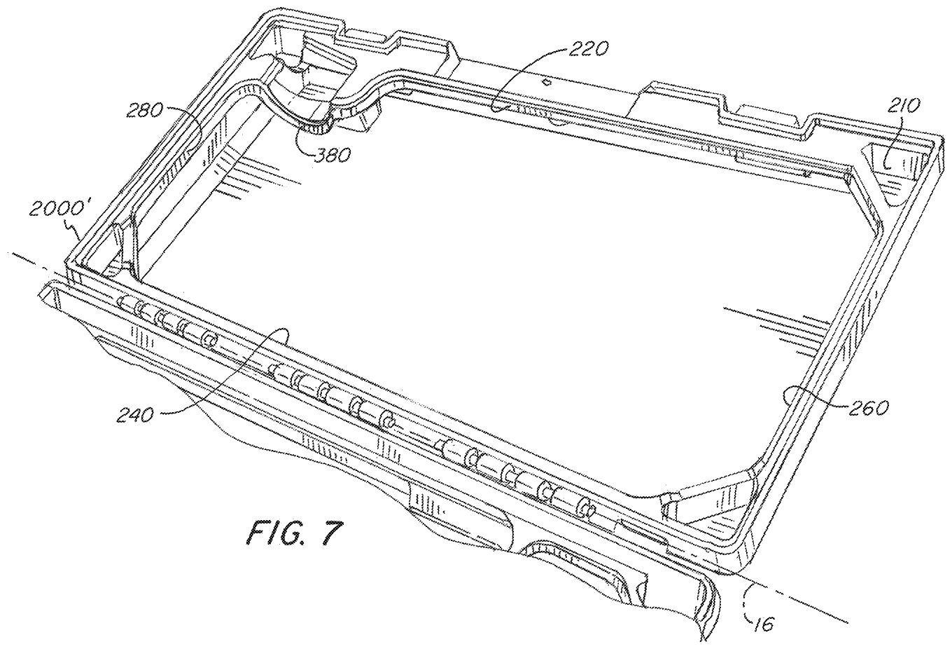

For example, Support 6 has an edge with portions 32, 30, 34, 35 which are located at different heights. As can also be seen, support 6 extends from edge 22 and support 14 extends from edges 22 and 28 and is located in corner 36. Depression 40 may extend partially into the space between the walls e.g. as shown in FIG. 5 the inner walls at support 14 do not touch at depression 40. However, it may be advantageous in certain circumstances for depression to create the touching or fused walls similar to depression 18. FIG. 5 further shows the height difference between edge 28 and the lower portion of the cut line 38 which contours to or accepts the particular end of the tool. As can be seen, the portion of the cut line 38 is a smooth curve rather than two straight sections which intersect. It is understood that other portions of the cut line may have similar smooth curve properties. It is understood that additional support(s) may extend from the other edge(s). FIG. 6 shows additional detail on support 6. Particularly, as can be seen, depressions 18 result in the two walls being fused together at their inner surfaces to create a plastic weld. This is accomplished during the blow molding process. In some cases, the structure of the mold which creates the depressions 18 may be fully or partially a secondary movement. E.g. the mold halves are closed and the plastic is expanded and once expanded there is a small space between the inner walls at the depressions 18 which is then closed by a punch (which does not cut the plastic). Ultimately, the perimeter of the case halves 2000/2000′ is relatively close in length or in certain cases shorter than the length of the cut line of the corresponding half e.g. 80%-125%. Furthermore, the cut line defines an internal perimeter of the single wall section and the corresponding two dimensional area (planform area) is relatively large compared to the area within the outer perimeter 2000/2000′. For example, the inner perimeter area as projected on a plane (planform area) is more than 50% of the area defined by the perimeter 2000/2000′. In certain aspects the internal area (within the cut line) it is more than 60%, more than 75%, more than 80%, more than 85% or even more particularly more than 90% than the outer perimeter area of the corresponding case half. This results in maximizing the amount of single wall section and thus minimizing use of plastic while still providing adequate structural support for the case via the indents e.g. 21 and the supports e.g. 6/14. The thickness of the case is relatively thin. Particularly, as seen from the view of FIG. 5, the distance between bottom and top of the case half is typically less than six inches, or more particularly, less than 4 inches or even more particularly less than 3 inches or even more particularly less than 2.5 or 2 inches. The total case thickness is typically less than 12 inches, more particularly less than 10, even more particularly less than 8 and in some embodiments less than 6, 5 or 4 inches in thickness.

FIG. 7 shows the upper half of the case which rotates about axis 16. Edges 220, 380, 280, 240, 260 are defined by the cut line for the upper half of the case. As can be seen, the support at the top left corner has a contoured cut line 380. This support is located in the corner and contours to the tool to be held, thus edge 380 is below the level of edge 280 and 220 such that the cut line varies in distance from the generally planar inner surface of the outer wall.

It should also be understood that FIG. 4 shows the interior (cut line) and exterior perimeters in two dimensions or the corresponding planform area(s). And that a top view of each of the case halves described herein would also show the corresponding planform area(s).

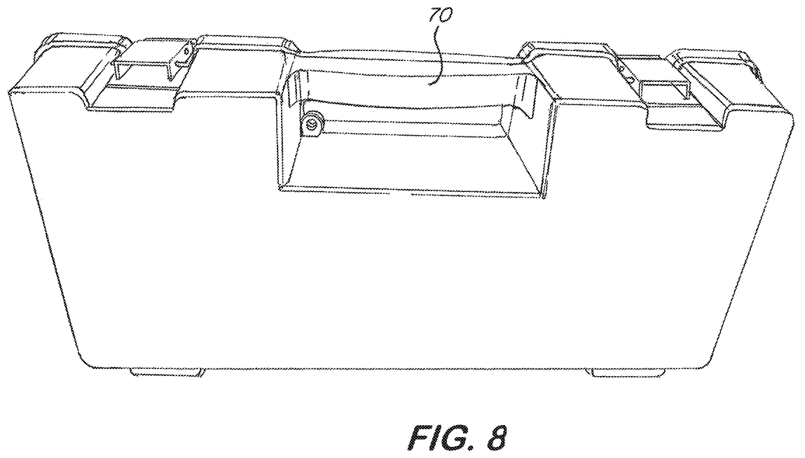

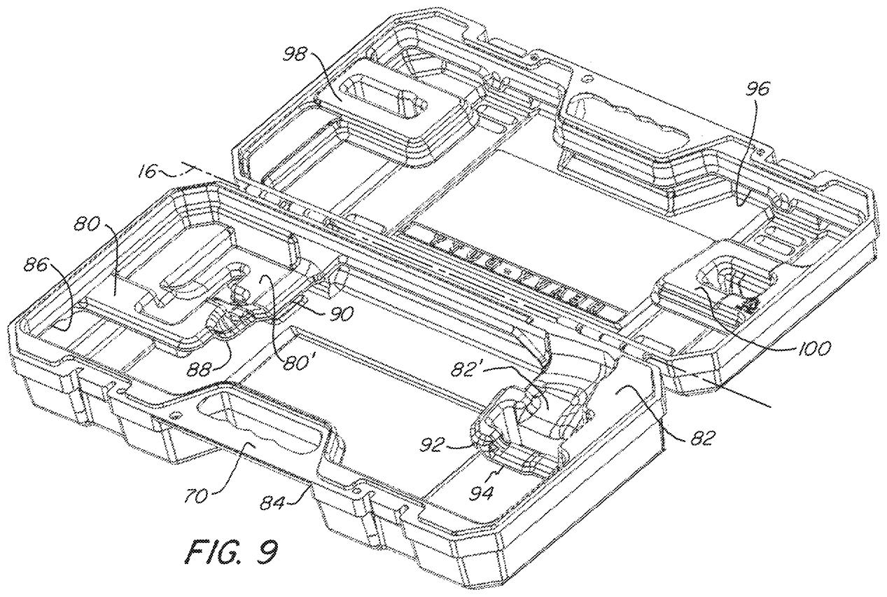

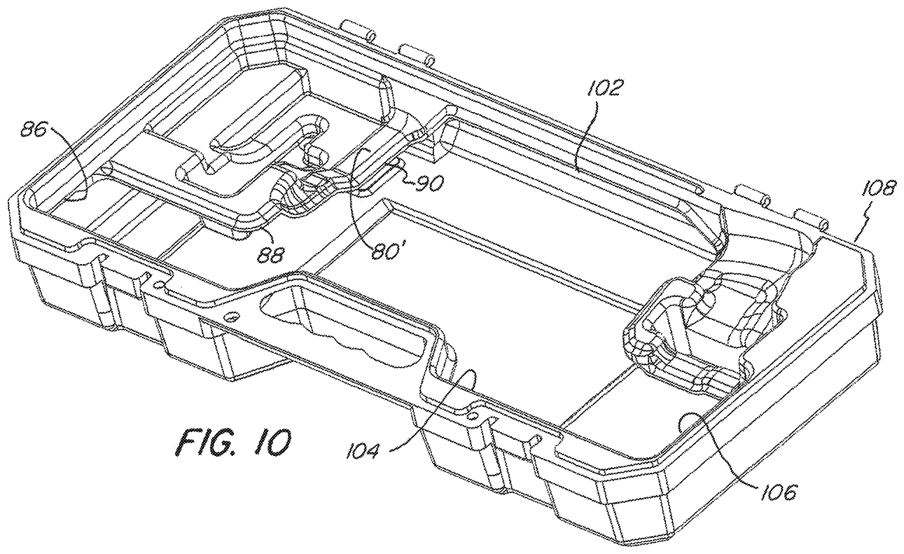

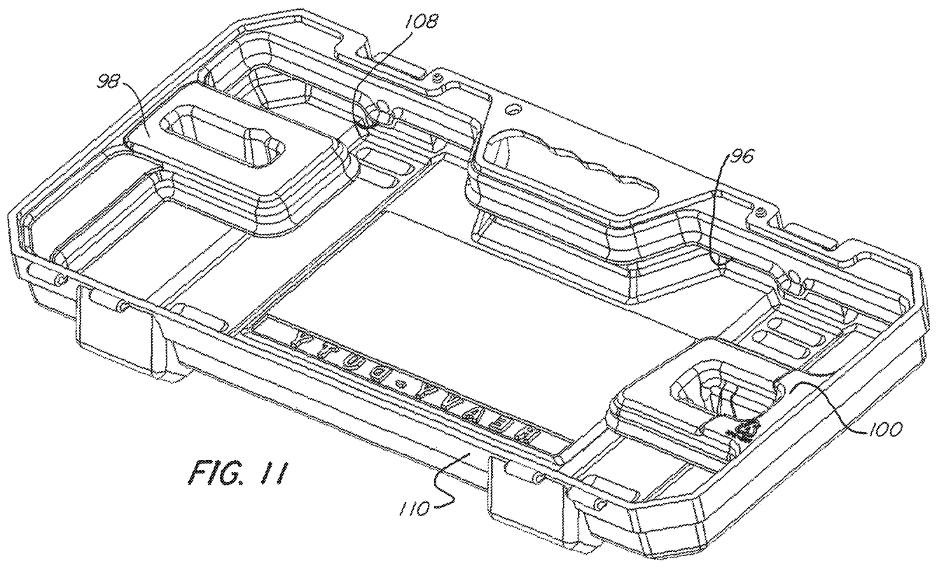

Referring to FIGS. 8-11, an alternate case is shown with an integrated handle 70. The lower half of the case has two corner supports 80/82 with contoured tool receiving surfaces 80′/82′. The supports 80/82 show double walled sections and the interior of the case is single wall which is separated by a cut line which has a number of sections e.g. 86, 88, 90, 91, 92, 94, 102, 106, 104. As can be seen, support 82 extends inward from edge 106 in one direction and inward from edge 102 in another direction. The cut line varies in height such that section 94 is lower than section 92, both of which are lower than edges 102/106. This provides for the edges of the contoured surface 82′ of one of the support. Similarly, support 80 extends inwards from both edge 86 and 102 has sections of the cut line 88 and 90 which are at different heights as compared to the edges 86/102. Thus also creates the edges of the contoured surface 80′ of the other support. Support 82 generally holds the trigger/handle end of the tool whereas the other support 80 holds the tool/blade/bit end of the tool. The upper half of the case is shown in FIG. 10 whereas the lower half is shown in FIG. 9. These halves have perimeters 108/110 around the outer edge thereof.

Although the invention has been described with reference to a particular arrangement of parts, features and the like, these are not intended to exhaust all possible arrangements or features, and indeed many other modifications and variations will be ascertainable to those of skill in the art.

What is claimed is:

1. A blow molded tool case comprising:
a first section and a second section, said first and second sections configured to pivot relative to each other and being blow molded;
said first and second sections each having a length, height and thickness, the length measured along the pivot between the first and second sections, the thickness being less than the height, the thickness being measured in a first direction from an outer surface of the respective section to a parting line of the tool case between the first and second sections when the tool case is closed;
a double wall section and a single wall section separated by a cut line;
said cut line defining a first edge and a second edge opposite the first edge and further defining a third edge and a fourth edge opposite the third edge;
a portion of said double wall section extending inwards from the first edge such that a part of the cut line defining said portion of said double wall section has different heights relative to the first edge measured in the first direction.

2. The tool case of claim 1 wherein said double wall section and said single wall section are on said first section.

3. The tool case of claim 1 wherein said double wall section comprises at least a first and a second double wall section and said single wall section comprises at least a first and a second single wall section;
said first double wall section and said first single wall section located on said first section;
said second double wall section and said second single wall section located on said second section.

4. The tool case of claim 1 further comprising:
said portion of said double wall section extends inwards from two locations on said first edge towards a middle of the first section without extending all the way across the first section.

5. The tool case of claim 1 further comprising:
said portion of said double wall section extends inwards from said third edge such that the part of the cut line extends inwards from said first edge and then outwards towards said third edge.

6. The tool case of claim 1 wherein the first, second, third and fourth edges are at an equal height.

7. The tool case of claim 1 wherein the first and second edges are parallel and the third and fourth edges are parallel.

8. The tool case of claim 1 wherein said double wall section includes one or more supporting portions where outer and inner walls of the first section are fused together.

9. The tool case of claim 1 further comprising:
a tool having a first contoured surface;
said double wall section having a second contoured surface such that the first contoured surface inter-fits the second contoured surface;
an edge of the second contoured surface being defined by the part of the cut line which has different heights relative to the first edge.

10. The tool case of claim 1 further comprising:
a contoured surface on said double wall section having an edge defined by the part of the cut line which has different heights relative to the first edge.

11. The tool case of claim 1 further comprising:
a first perimeter of the first portion defined at the case parting line;
a second perimeter of the second portion defined at the case parting line;
the cut line is a first cut line which has a first length which is the longest cut line of the first blow molded portion;
said second blow molded portion having a second cut line which separates a double wall and a single wall portion of the second blow molded portion, the second cut line having a second length which is the longest cut line of the second blow molded portion;
a sum of the first and second lengths is 75% or more than a sum of lengths of the first and second perimeters.

12. A blow molded case comprising:
a first blow molded portion;
a second blow molded portion configured to pivot relative to said first blow molded portion and meet at a case parting line when the case is in a closed position;
a first outer perimeter of the first blow molded portion defined at the case parting line;
a second outer perimeter of the second blow molded portion defined at the case parting line;
said first blow molded portion having a first cut line which separates a double wall and a single wall portion of the first blow molded portion, the first cut line having a first length which is a longest cut line of the first blow molded portion;
said second blow molded portion having a second cut line which separates a double wall and a single wall portion of the second blow molded portion, the second cut line having a second length which is a longest cut line of the second blow molded portion;
a sum of the first and second lengths is 75% or more than a sum of lengths of the first outer perimeter and the second outer perimeter.

13. The blow molded case of claim 12 further comprising:
one or more depressions located in at least one of the double wall portions, the one or more depressions being defined by first and second walls of the double wall portion being in contact.

14. The blow molded case of claim 13 wherein the contact between the first and second walls fuses the first and second walls together in a plastic weld.

15. The blow molded case of claim 12 wherein the sum of the first and second lengths is greater than the sum of lengths of the first and second perimeters.

16. The blow molded case of claim 12 wherein the first outer perimeter defines a first planform area on a plane and the second outer perimeter defines a second planform area on the plane;
the first cut line defining a third planform area on the plane and the second cut line defining a fourth planform area on the plane;
a sum of the third and fourth planform areas is at least 50% of a sum of the first and second planform areas.

17. The blow molded case of claim 16 wherein the sum of the third and fourth planform areas is at least 75% of the sum of the first and second planform areas.

18. A blow molded case comprising:
a first blow molded portion;
a second blow molded portion configured to pivot relative to said first blow molded portion about an axis and meet at a case parting line when the case is in a closed position;
said first blow molded portion having at least one first double wall portion and at least one first single wall portion separated by a cut line, the at least one first double wall portion extending inward in an inward direction transverse to the axis to define a first support wherein the cut line around the first support has different heights measured in a thickness direction perpendicular to the inward direction and the axis.

19. The blow molded case of claim 18 further comprising:
said second blow molded portion having at least one second double wall portion and at least one second single wall portion separated by a cut line, the at least one second double wall portion defining a second support and extending inward in the inward direction wherein the cut line around the second support has different heights measured in the thickness direction.

20. The blow molded case of claim 18 further comprising:
a second at least one first double wall portion defining a second support and located in a corner of said first blow molded portion and the cut line around the second at least one first double wall portion has different heights measured in the thickness direction.

21. The blow molded tool case of claim 20 wherein the first and second supports respectively are configured to support a handle end and a tool end of a tool.

22. The blow molded case of claim 18 further comprising:
one or more depressions located in the first support, the one or more depressions being defined by first and second walls of the corresponding double wall portion being in contact.

23. The blow molded case of claim 22 wherein the one or more depressions make up a first area where the first and second walls are in contact which is less than 5% of an area defined by a perimeter of the first blow molded portion.

24. The blow molded case of claim 18 wherein a first planform area between the cut line and a perimeter of the first blow molded portion is less than 20% of a second planform area defined by a perimeter of the first blow molded portion.

25. A blow molded case comprising:
a first blow molded portion;
a second blow molded portion configured to pivot relative to said first blow molded portion and meet at a case parting line when the case is in a closed position;
a first outer perimeter of the first blow molded portion defined at the case parting line;
said first blow molded portion having a first cut line within the first outer perimeter which separates a double wall and a single wall portion of the first blow molded portion;
the first outer perimeter defines a first planform area on a plane;
the first cut line defining a first cutline planform area on the plane;
the first cutline planform area is at least 60% of the first planform area.

26. The blow molded case of claim 25 further comprising:
a second outer perimeter of the second blow molded portion defined at the case parting line;
said second blow molded portion having a second cut line which separates a double wall and a single wall portion of the second blow molded portion;
the second outer perimeter defines a second planform area on the plane;
the second cut line defining a second cutline planform area on the plane;
the second cutline planform area is at least 50% of the second planform area.

27. The blow molded case of claim 26 wherein the second cutline planform area is at least 75% of the second planform area.

28. The blow molded case of claim 27 wherein the first cutline planform area is at least 75% of the first planform area.

29. The blow molded case of claim 25 wherein the first cutline planform area is at least 75% of the first planform area.

30. The blow molded case of claim 25 wherein a length of the first cutline is 70% or more of a length of the first outer perimeter.

31. The blow molded case of claim 30 wherein the length of the first cutline is between 70-130% of the length of the first outer perimeter.

32. The blow molded case of claim 25 further comprising a handle portion integrally formed in: the first blow molded portion, the second blow molded portion or in the first and second blow molded portions.
